(19) United States
(12) Patent Application Publication
(10) Pub. No.: US 2022/0026879 A1
(43) Pub. Date: Jan. 27, 2022

(54) PREDICTIVE MAINTENANCE OF COMPONENTS USED IN MACHINE AUTOMATION

(71) Applicant: Micron Technology, Inc., Boise, ID (US)

(72) Inventor: Poorna Kale, Folsom, CA (US)

(21) Appl. No.: 16/936,323

(22) Filed: Jul. 22, 2020

(51) Int. Cl. G05B 19/4155; G06Q 10/00; G06Q 50/04; G07C 3/00; G06N 3/08; G06F 8/65

(52) U.S. Cl. CPC G05B 19/4155; G06Q 10/20; G06Q 50/04; G05B 2219/31229; G06N 3/08; G06F 8/65; G07C 3/005

(57) ABSTRACT

Systems, methods, and apparatus for prediction of maintenance service for machines. In one example, one or more sensors are configured to generate a sensor data stream during operation of a machine. An artificial neural network (ANN) is configured to receive the sensor data stream and predict a maintenance service for the machine based on the sensor data stream. For example, the ANN can be trained using the sensor data stream collected within a predetermined time period of a machine being newly-installed in an assembly line or other industrial automation facility. The machine can be considered to be operating in a normal condition during the predetermined time period such that the ANN can be trained to detect anomaly that deviates from the normal patterns of the sensor data stream. For example, the ANN can be a spiking neural network (SNN).

### FIELD OF THE TECHNOLOGY

At least some embodiments disclosed herein relate to maintenance services for machines in general, and more particularly, but not limited to predictive determination of the timing and/or type of maintenance services to be provided for machines.

### BACKGROUND

Maintenance is often performed for physical machines having components that wear out over time with continued operation. The wear that occurs during operation can be, for example, due to physical wear from moving parts of a machine, or from exposure of a machine's components to various environments (e.g., harsh chemicals, and/or extreme cold or hot temperatures).

Maintenance for machines (e.g., an industrial manufacturing apparatus or a motor vehicle) is conventionally scheduled based on a predetermined milestone of operations. For example, a routine maintenance service can be scheduled once for every three or six months, or after a predetermined product production volume, or distance traveled.

When a component of a machine breaks down or malfunctions during the operation of the machine, such an incident can be a safety hazard. After such an incident occurs, travel or other logistics (e.g., parts delivery) required for the service of the machine may by necessity be scheduled at an inconvenient time.

Recent developments in the technological area of automated machines (e.g., automated assembly lines or other industrial facilities, or autonomous motor vehicles) allow a computing system to operate, at least under some conditions, control elements of a motorized or other type of machine without assistance from a human operator.

For example, sensors (e.g., cameras and radars) can be installed on a motor vehicle to detect the conditions of the surroundings of the vehicle traveling on a roadway. A computing system installed on the vehicle analyzes the sensor inputs to identify the conditions and generate control signals or commands for the autonomous adjustments of the direction and/or speed of the vehicle, with or without any input from a human operator of the vehicle.

In some arrangements, when a computing system recognizes a situation in which the computing system may not be able to continue operating the vehicle in a safe manner, the computing system alerts a human operator and requests the human operator to take over the control of the vehicle and drive manually, instead of allowing the computing system to drive the vehicle autonomously.

U.S. Pat. No. 9,533,579, entitled “Electronic Control Apparatus for Electrically-Driven Vehicle” and published Jan. 3, 2017, discloses an electronic control apparatus of a vehicle that has a self-diagnosis function.

Autonomous driving (or in some cases other machine operation) typically involves use of an artificial neural network (ANN) for the identification of events and/or objects that are captured in sensor inputs. In general, an artificial neural network (ANN) uses a network of neurons to process inputs to the network and to generate outputs from the network.

For example, each neuron in the network receives a set of inputs. Some of the inputs to a neuron may be the outputs of certain neurons in the network; and some of the inputs to a neuron may be the inputs provided to the neural network. The input/output relations among the neurons in the network represent the neuron connectivity in the network.

For example, each neuron can have a bias, an activation function, and a set of synaptic weights for its inputs respectively. The activation function may be in the form of a step function, a linear function, a log-sigmoid function, etc. Different neurons in the network may have different activation functions.

For example, each neuron can generate a weighted sum of its inputs and its bias and then produce an output that is the function of the weighted sum, computed using the activation function of the neuron.

The relations between the input(s) and the output(s) of an ANN in general are defined by an ANN model that includes the data representing the connectivity of the neurons in the network, as well as the bias, activation function, and synaptic weights of each neuron. Using a given ANN model a computing device computes the output(s) of the network from a given set of inputs to the network.

For example, the inputs to an ANN network may be generated based on camera inputs; and the outputs from the ANN network may be the identification of an item, such as an event or an object.

A spiking neural network (SNN) is a type of ANN that closely mimics natural neural networks. An SNN neuron produces a spike as output when the activation level of the neuron is sufficiently high. The activation level of an SNN neuron mimics the membrane potential of a natural neuron. The outputs/spikes of the SNN neurons can change the activation levels of other neurons that receive the outputs. The current activation level of an SNN neuron as a function of time is typically modeled using a differential equation and considered the state of the SNN neuron. Incoming spikes from other neurons can push the activation level of the neuron higher to reach a threshold for spiking.

Once the neuron spikes, its activation level is reset. Before the spiking, the activation level of the SNN neuron can decay over time, as controlled by the differential equation. The element of time in the behavior of SNN neurons makes an SNN suitable for processing spatiotemporal data. The connectivity of SNN is often sparse, which is advantageous in reducing computational workload.

In general, an ANN may be trained using a supervised method where the parameters in the ANN are adjusted to minimize or reduce the error between known outputs resulted from respective inputs and computed outputs generated from applying the inputs to the ANN. Examples of supervised learning/training methods include reinforcement learning, and learning with error correction.

Alternatively, or in combination, an ANN may be trained using an unsupervised method where the exact outputs resulted from a given set of inputs is not known before the completion of the training. The ANN can be trained to classify an item into a plurality of categories, or data points into clusters. Multiple training algorithms can be employed for a sophisticated machine learning/training paradigm.

### BRIEF DESCRIPTION OF THE DRAWINGS

The embodiments are illustrated by way of example and not limitation in the figures of the accompanying drawings in which like references indicate similar elements.

FIG. 1 shows a system in which machines are monitored by sensors for the prediction of maintenance services using an artificial neural network(s), according to some embodiments.

FIG. 2 shows a facility including a computer system that collects sensor data used to monitor various types of machines, and controls the machines based on a prediction of future maintenance services made using an artificial neural network(s), according to some embodiments.

FIGS. 3 and 4 illustrate training of artificial neural networks for maintenance service prediction, according to some embodiments.

FIGS. 5-7 show methods of predictive maintenance service, according to some embodiments.

### DETAILED DESCRIPTION

At least some embodiments below relate to predictive determination of the timing and/or type of maintenance services to be provided for machines (e.g., as used in industrial automation). In some embodiments, systems, methods and apparatus are used to process collected sensor data associated with the operation of one or more machines to facilitate predictive maintenance. The collected sensor data is analyzed using one or more artificial neural networks (ANNs).

In one embodiment, a memory device collects sensor data from a machine (e.g., a machine that produces memory products for installation in computing devices by original equipment manufacturer (OEM) customers). In one example, the memory device may be mounted in or nearby the machine, or may be wirelessly connected to sensors of the machine. In one example, the memory device is a solid-state drive (SSD) mounted in the machine. The data collected by the memory device is used to predict maintenance services for the machine. The machine may be, for example, a manufacturing machine in an assembly line of several machines (e.g., in a semiconductor wafer fabrication facility), an autonomous vehicle, or systems that provide electrical, chemical, mechanical, data, and/or communication services for a physical structure (e.g., a building or house).

As used herein, a “machine” includes, for example, any apparatus that has physical components. In one example, a machine is a mechanically, electrically, or electronically-operated device for performing one or more tasks. In one example, a machine has physical components that move relative to one another (e.g., an autonomous vehicle). In one example, a machine has physical components that cooperate in an electrical and/or physical manner (e.g., a battery). In one example, a machine has a physical component that is controlled by a controller or other electronic device (e.g., a radio used for wireless communications).

Before a component of a machine breaks down or malfunctions during the operation of the machine, there can be indication of whether the component needs replacement or maintenance. Such indications may not be noticeable to a typical operator or user of the machine.

Prior approaches to maintenance service suffer from the technical problems of failing to adequately monitor a need for service, to inform an operator of such need, and/or to cause a change in operation of a machine to avoid a future technical malfunction. This can lead to physical injury or death in some cases, and to machine or product damage in other cases. In one example, product damage may not be discovered until after product has been shipped to customers.

Various embodiments of the present disclosure provide a technological solution to one or more of the above technical problems. In some embodiments, sensor data is collected for a machine being monitored. The sensor data is analyzed using an ANN to predict a probability of component failure for the machine. The prediction can be used to schedule maintenance services (e.g., for a particular identified component(s)), which can reduce or eliminate the chances of incidents where a component of the machine breaks down or malfunctions during the operation of the machine, such as at a critical time where providing adequate service is difficult or impossible (e.g., operation of a vehicle on a roadway). Further, the prediction allows the service to be scheduled at a convenient time, for which it is more technically and/or cost efficient to implement the service.

In one embodiment, a sensor data stream is received from one or more sensors (e.g., chemical, temperature, and/or image sensors) that collect data associated with the operation of a machine. The received sensor data stream is stored in a non-volatile memory (e.g., a NAND flash memory device that is internal to the machine, mounted on the machine, or wirelessly coupled to a controller of the machine). A maintenance service is predicted based on an output from an artificial neural network (ANN). In one example, the ANN is executed by a controller of the memory device. A portion of the sensor data stream is provided as an input to the ANN. Based on the output, a signal is sent or provided to a controller of the machine (e.g., over a network, wirelessly via a Bluetooth connection, etc.) to cause a change in the operation of the machine. In one example, the change is a scheduling of a service event (e.g., a self-maintenance operation implemented by the memory device to reduce excessive memory wear in certain portions of a NAND flash storage media of the memory device).

In one embodiment, an artificial intelligent (AI)-enabled memory product is used in an industrial automation system to detect anomaly in data traffic for the system. For example, a memory device having a spike detecting capability can be used to implement a spiking neural network (SNN) to detect the anomaly. In one example, the data traffic is data sent from various sensors to a centralized location of the industrial automation system (e.g., a computing device; a server implemented in the cloud that communicates with one or more machines in the system).

Additional sensors can be added as desired to the industrial automation system to collect sensor data relevant to the health/operation of the industrial automation system. Such sensors can include, for example, microphones to pick up noises, digital cameras, pressure sensors, stress sensors, etc. In one example, the sensors provide data to a computing device over a local area controller network of one or more machine(s).

During a period of normal operation, the SNN is trained to recognize normal data patterns. Subsequently, the SNN detects anomaly that deviates from the normal patterns. Based on the detection, a predictive maintenance is scheduled. The SNN can be trained to predict common troubles by inducing/reproducing the troubles in the system. In some cases, the SNN can be used in conjunction with a black box data recorder that stores a recent set of data such that when an operational or other problem occurs, the black box data can be retrieved to train the SNN to recognize the indications to the trouble ahead of time. Subsequently, the SNN can suggest pre-emptive maintenance operations to avoid the foregoing troubles.

In one embodiment, a service prediction system includes a communication interface (e.g., a radio transceiver) to receive sensor data collected by sensors during operation of several machines. The system further includes memory to store the received sensor data. The received sensor data includes normal data patterns associated with the operation of the machines. The system further includes a computing device (e.g., an SSD that includes the memory and a processing device) to predict a maintenance service for one or more of the machines based on an output from an artificial neural network (ANN). A portion of the received sensor data is used as an input to the ANN. The maintenance service is predicted by detecting an anomaly that deviates from at least one of the normal data patterns (e.g., using an SNN, as described herein).

In one embodiment, sensors are installed in or nearby a machine system to collect data during its routine operations; and the sensor data can be used to predict whether and how soon a component needs replacement or maintenance. The sensor data can be provided as input to an artificial neural network (ANN) (e.g., spiking neural network (SNN)) of an artificial intelligent (AI) system to train itself (e.g., using an unsupervised machine learn technique) in a time period in which the machine is expected to operate normally.

In one embodiment, the training can customize the ANN for the specific operating environment(s) of the operator or user of the machine and/or the specific operating environment of the machine. Subsequently, when the operating data deviates the normal mode, the ANN can detect abnormal conditions. The AI system can be used to suggest a maintenance service and/or identify the component that likely needs replacement or maintenance.

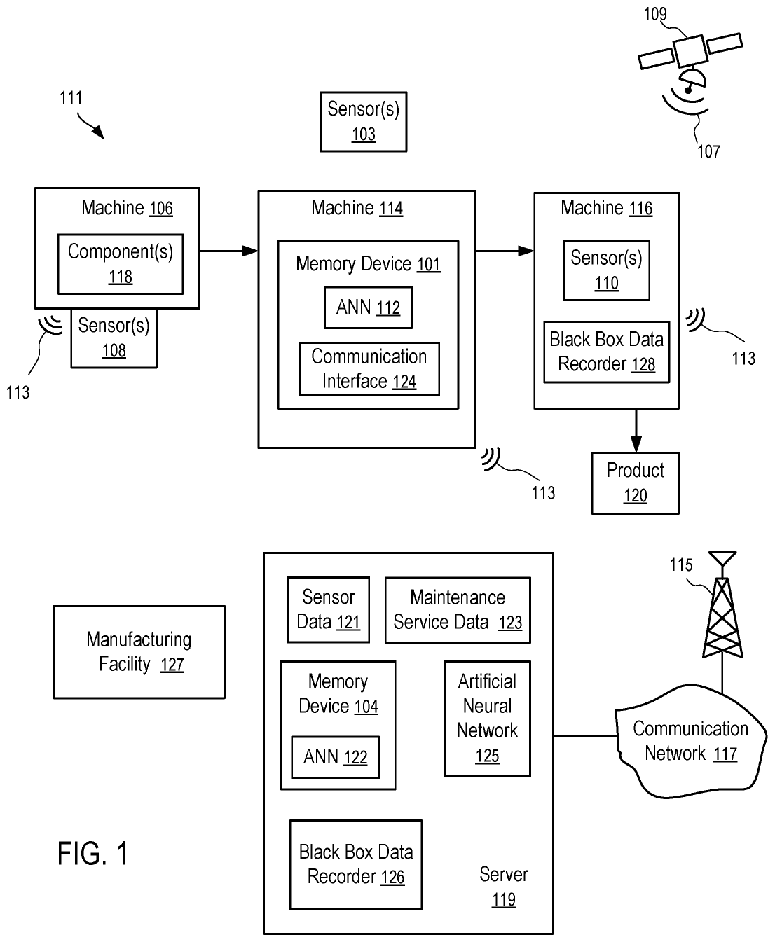

FIG. 1 shows a system in which machines 106, 114, 116 are monitored by sensors 103, 108, 110 for the prediction of maintenance services using an artificial neural network (e.g., 112, 122, and/or 125), according to some embodiments.

In one embodiment, an assembly line or other automated system 111 having the machines (e.g., machines located in manufacturing facility 127) also includes sensors 103, 108, 110 that provide sensor data to memory device 104 (e.g., using communication network 117). The memory device 104 is configured to use an artificial neural network (ANN) 122 to predict/identify a need for a maintenance service based on the data collected by the sensors. In some embodiments, the machines of automated system 111 (e.g., an assembly line) are mobile.

In one embodiment, the sensor data from assembly line 111 is collected by memory device 101, which is located in machine 114. Memory device 101 includes an artificial neural network 112, which can be used to predict maintenance services based on the data collected by memory device 101. In one example, the predicted maintenance service is for machine 114. In one example, the predicted maintenance service is alternatively and/or additionally for machine 106 and/or 116.

Machine 114 communicates with other machines 106, 116 over a network (e.g., a local area network). Also, each of machines 106, 114, 116 may communicate with server 119 over communication network 117.

In one embodiment, collected sensor data is stored in non-volatile memory of memory device 101 and/or memory device 104. In some cases, maintenance services can be predicted based on collected data stored in both memory device 101 and 104. In one example, ANN 112 and ANN 122 are used in combination to generate output used for predicting maintenance services. For example, an output from ANN 112 can be an input to ANN 122.

In one embodiment, records associated with the servicing and/or physical condition of machines 106, 114, 116, is stored as maintenance service data 123. Sensor data 121 is stored at server 119 and can include sensor data collected from sensors 103, 108, 120. ANN 125 of server 119 can be trained using sensor data 121 and maintenance service data 123 that corresponds to a period of normal operation of machines 106, 114, 116. An output of ANN 125 is then used to predict maintenance services based on recently-collected sensor data received from sensors 103, 108, 110.

The sensor(s) (e.g., 103, 108, 110) can include digital cameras, lidars, radars, ultrasound sonars, brake sensors, speed sensors, acceleration sensors, airbag sensors, a GPS (global positioning system) receiver, audio sensors/microphones, vibration sensors, force/stress sensors, deformation sensors, motion sensors, temperature sensors, etc. Some of the sensors can be configured primarily to monitor the environment of the assembly line 111; and other sensors can be configured primarily to monitor the operating condition of one or more components of a machine (e.g., an internal combustion engine, an electric motor, a battery, etc.). In one example, components are components 118 of machine 106.

In one embodiment, the outputs of the sensor(s) as a function of time are provided as a sensor data stream to one or more of the ANNs (e.g., 112, 122, 125) to provide machine operation control (e.g., autonomous operation) and/or maintenance prediction. In some cases, one of server 119, memory device 101, or memory device 104 can act as a master controller to distribute portions of an ANN to various processing devices based on a current processing load of each respective processing device. In one example, the distributed portions of the ANN can be distributed amongst processing devices for memory device 101, memory device 104, and server 119. In one example, the portions are distributed based on an output of ANN 112, 122, and/or 125.

In one example, the one or more ANN(s) can be used to process video images monitoring assembly line output, assembly line speed, vibration data for portions of the assembly line, etc. In one example, the assembly line output is product 120 (e.g., a memory device).

In one example, each machine has a wireless communication device to communicate with remote server 119 via wireless signals 113 and a communication network 117. The remote server 119 can be configured at the same location as, or a location away from, assembly line 111. In one example, each machine may provide some sensor data 121 to the server 119 and receive control signals from the server 119 based on output from the ANN 125.

One example of the communication network 117 is a cell phone network having one or more base stations (e.g., 115) to receive the wireless signals (e.g., 113). Another example of the communication network 117 is internet, where the wireless local area network signals (e.g., 113) transmitted by a machine (e.g., via memory device 101) is received in an access point (e.g., 115) for further communication to the server 119. In some implementations, the machine uses a communication link 107 to a satellite 109 or a communication balloon to communicate with the server 119.

The server 119 can also communicate with one or more maintenance service facilities (e.g., 127) to receive maintenance service data 123 of the machines (e.g., 106, 114, 116). In one example, machines 106, 114, 116 are part of manufacturing facility 127. In one example, the machines are in a different manufacturing facility, but data from machines having similar operational characteristics, which are located in facility 127, are used to train one of more of the ANNs.

The maintenance service data 123 can include inspection records and/or service records of components of any of the machines above. For example, the inspection records and/or service records can indicate the degree of wear and tear of components inspected during their services at the maintenance service facilities (e.g., 127), the identification of failed or malfunctioning components, etc. The sensor data 121 of the machines in a time period prior to the services and the maintenance service data 123 can be used to train one or more of the above ANNs to predict the probability of a component requiring a maintenance service.

The updated ANN can be used to predict and suggest a maintenance service for a machine based on sensor data 121 received in a recent period of time. Alternatively, an updated ANN can be transmitted to a machine (e.g., to update ANN 112). The machine with the update ANN can use the data generated from the sensors during routine operations of the machine to predict and suggest a maintenance service for itself. The predicted maintenance service by the machine can be sent to server 119 and/or another computing device to cause scheduling or another action associated with servicing the machine. In this case, the machine is automatically self-reporting a need for service.

In one embodiment, memory device 101 is configured to record sensor data for a period of time that can be used in ANN 112 and/or ANN 125 for predictive maintenance. Maintenance prediction is typically for a relative long period of time (e.g., a few days, weeks and/or months).

In one embodiment, sensor data is recorded for the review of an accident, collision, or near collision involving an autonomous vehicle (e.g., over a short period of time such as, for example, 300 seconds or less prior to the accident). In one embodiment, black box data recorder 128 is configured to record sensor data for the review/analysis of an accident or failure associated with machine 116. The recorded sensor data is used to train an ANN used to predict future such failures based on sensor data subsequent to the failure. In one embodiment, black box data recorder 126 records sensor data received from one or more of machines 106, 114, 116. Data from recorder 126 can be used to train ANN 125 for prediction of maintenance services to avoid future failures, as described above.

In one embodiment, memory device 101 stores sensor data of a period of time prior to machine 114 being sent to a service facility. The service facility can download the sensor data 121 from the memory device 101 and provide the sensor data 121 and the corresponding maintenance service data 123 to the server 119 to facilitate the training of the ANN 125.

Optionally, or in combination, memory device 101 is configured with a machine learning module to customize and/or train ANN 112 for predictive maintenance. For example, the machine learning module of the memory device 101 can be used to calibrate the ANN 112 to account for the typical/daily environment in which machine 114 is being operated and/or preferences of the operator of machine 114.

In one example, during a period of time when machine 114 is expected to be operated under a typical/daily environment with healthy components, the sensor data generated by sensors associated with machine 114 (e.g., sensors installed in machine 114) can be used to train the ANN 112 to recognize the patterns of sensor data that represent trouble-free operations. Such patterns can vary for different machines (e.g., 106, 114, 116) based on their routine operating environments and characteristics. The training allows the ANN 112 to detect deviations from the recognized normal patterns and report anomaly for maintenance predictions.

For example, the ANN 112 can include an SNN configured to classify time-based variations of sensor data and/or detect deviation from known patterns of sensor data of the machine 114 operated in the normal/healthy condition but in a customized environment (e.g., a procedure used for a particular customer product) and/or operated using a customized pattern.

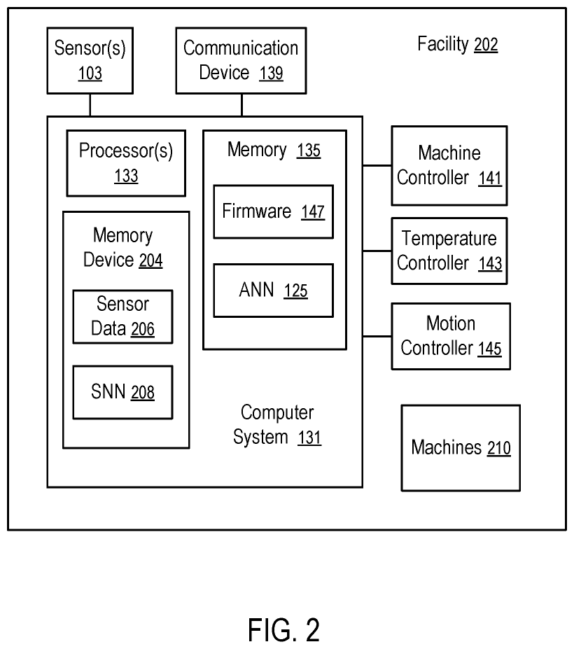

FIG. 2 shows a facility 202 including a computer system 131 that collects sensor data from sensors 103 used to monitor various machines 210, according to some embodiments. In one embodiment, computer system 131 controls the machines 210 based on a prediction of future maintenance services made using an artificial neural network (e.g., ANN 125 and/or spiking neural network (SNN) 208). In one embodiment, computer system 131 predicts a maintenance service based on an output of the ANN(s). In one example, computer system 131 is used to predict maintenance services for machines 106, 114, 116 of FIG. 1.

The one or more sensors 103 associated with a machine can include a visible light camera, an infrared camera, a lidar, radar, or sonar system, a peripheral sensor, a global positioning system (GPS) receiver, a satellite positioning system receiver, a brake sensor, and/or an airbag sensor. Further, the sensors 103 can include audio sensors (e.g., microphone) configured to monitor noises from various components and locations in the machine, a vibration sensor, a pressure sensor, a force sensor, a stress sensor, and/or a deformation sensor configured to measure loads on a component of the machine, accelerometers and/or gyroscope sensors measuring the motions of some components of the machine, etc. Such sensors can be used to monitor the operating status and/or health of the components for predictive maintenance.

The sensor(s) 103 can provide a stream of real time sensor data to the computer system 131. The sensor data generated by a sensor 103 of a machine can include an image that captures an object using a camera that images using lights visible to human eyes, or a camera that images using infrared lights, or a sonar, radar, or LIDAR system. Image data obtained from at least one sensor of the machine is part of the collected sensor data for recording in memory device 204 or in other memory of computer system 131.

In one example, a camera can be used to obtain information regarding a machine, which can be processed by the ANN 125 to generate control signals for the machine. For example, a camera can be used to monitor the operation state/health of a component of the machine, which can be processed by the ANN 125 to predict or schedule a maintenance service.

The sensor data generated by sensor 103 of a machine can include an audio stream that captures the characteristics of sounds at a location on or near a machine, such as a location near an engine, a motor, a transmission system, a wheel, a door, etc. The audio data obtained from at least one sensor 103 can be part of the collected sensor data for recording in the memory device 204 and/or as input to the ANN 125 and/or SNN 208. For example, the audio and/or image stream can be used to monitor the operation state/health of a component of a machine (e.g., a reaction chamber, a photolithography machine, an electric motor), which can be processed by the ANN or SNN to predict or schedule a maintenance service.

Facility 202 includes a communication device 139 used by computer system 131 to communicate with machines 210 and sensors 103. For example, communication device 131 is used to send control signals to machines 210. Optionally, the communication device 139 can establish a connection to a mobile device of an operator to inform the operator of the recommended maintenance service and/or the recommended date of the service, to calendar an appointment, etc.

Computer system 131 is connected to a control of various machines, such as a directional control, a motion control, an acceleration control, etc. In some embodiments, the assembly line 111 in the system of FIG. 1 uses machines having a similar configuration and/or similar components. In one embodiment, these controls include machine controller 141, temperature controller 143, and/or motion controller 145. In one example, temperature controller 143 varies an operating temperature of the reactor or other chamber of a machine used to manufacture semiconductor products. In one example, motion controller 145 varies movement of product through an assembly line (e.g., by controlling robotics on a package conveyer system).

In one embodiment, machine controller 141 implements a service process on a machine in response to a command from computer system 131. In one example, the command is based on output of ANN 125 and/or SNN 208. In one example, the service process performs a maintenance action for a memory device (e.g., NAND flash device) of a machine.

In one embodiment, sensor data collected by sensors 103 is stored in memory device 204 as sensor data 206. In one example, computer system 131 stores sensor data by processor 133 sending a write command to memory device 204. In one example, computer system 131 reads sensor data 206 by processor 133 sending a read command to memory device 204.

A portion of sensor data 206 is used to train an artificial neural network that includes spiking neural network (SNN) 208. Then, SNN 208 uses a subsequently-stored portion of sensor data 206 to predict a maintenance service.

In one embodiment, ANN 125 is used for object detection, recognition, identification, and/or classification. The ANN 125 and/or another ANN (e.g., configured in the memory device 204) can be used to predict the probability of a component of a machine requiring a maintenance service (e.g., repair, replacement, or adjustment).

In one embodiment, the memory device 204 is configured to process sensor data at least partially for predictive maintenance with reduced computation burden on the processors 133 that are tasked to operate other components of a machine.

In one embodiment, some of the sensors 103 are used to collect data related to the health of the components of machines, and the sensor data generated by the sensors 103 can be used to predict the likelihood of imminent failure of a component. Such a prediction can be used to take emergency actions to put a machine into a safe state (e.g., by shutting down or changing a mode of operation).

The computer system 131 includes memory 135 storing firmware (or software) 147, including computer instructions for processor(s) 133 and data models for one or more ANNs.

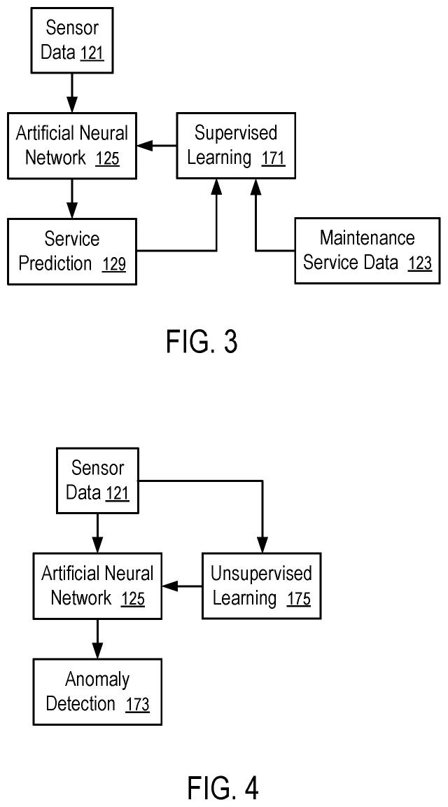

FIGS. 3 and 4 illustrate training of artificial neural networks for maintenance service prediction, according to some embodiments. In FIG. 3, a module 171 of supervised machine learning is used to train an artificial neural network 125 to minimize the differences between the service prediction 129 generated from the sensor data 121 and the maintenance service data 123. In other embodiments, ANN 112 or 122 can be similarly trained.

For example, the maintenance service data 123 can identify the measured wear and tear of a component as a function of time to predict a time to a recommended service. The sensor data 121 can be used in the ANN 125 to generate a predicted time to the recommended service. The supervised machine learning module 171 can adjust the artificial neural network 125 to reduce/minimize the difference between the time predicted based on the sensor data 121 and the time computed from the measurement of wear and tear.

For example, the maintenance service data 123 can identify a component that is replaced or repaired. The sensor data 121 recorded for a time period prior to the replacement or repair of the component can be used to calculate the times to the replacement or repair. Further, the segments of a stream of sensor data in the time period before the replacement or repair can be used in the ANN 125 to generate a prediction to the time of the replacement or repair. The supervised learning 171 can be used to adjust the ANN 125 to reduce the predicted time to the replacement or repair and the actual time to the replacement or repair.

The supervised learning 171 of FIG. 3 can be applied based on the sensor data of a population of machines and their maintenance service data 123 to generate a generic ANN for the population of the machines.

The supervised learning 171 of FIG. 3 can be applied in a machine based on the sensor data associated with the machine and its maintenance service data to generate a customized/personalized ANN for the population of the machines. For example, a generic ANN can be initially used in a machine; and the sensor data of the machine and its maintenance service data can be used to further train the ANN 125 for customization/personalization of the ANN 125 (e.g., the ANN used to control the machine).

In FIG. 4, a module 175 of unsupervised machine learning is used to train or refine an artificial neural network 125 to facilitate anomaly detection 173. The unsupervised machine learning module 175 is configured to adjust the ANN (e.g., SNN 208) based on classification, clustering, or recognized pattern in the sensor data 121 such that a degree of deviation from the classification, clustering, or recognized pattern in the sensor data 121 generated in a recent time period can be used to signal the detection 173 of anomaly. Anomaly detection 173 allows a machine to be scheduled for inspection in a maintenance service facility. Optionally, after the inspection, maintenance service data can be used to apply a supervised learning 171 to generate more precise predictions to a service, as in FIG. 3.

Typically, a machine can be assumed to be operating in a normal/healthy condition in a certain time period. For example, after a new machine is initially installed for service, the machine can be assumed to provide trouble-free services for at least a period of time (e.g., a few months). For example, after a time period following the replacement or repair of a component, the component can be assumed to provide trouble-free service for at least a period of time (e.g., a few months or a year). Thus, the sensor data 121 obtained during this period of time can be pre-classified as “normal” to train the ANN 125 using an unsupervised learning 175, or a supervised learning 171.

For example, the sensor data 121 collected via during the “normal” service time period of the machine or a component can be classified via an unsupervised learning 175 into a number of clusters. Different clusters may correspond to different types of normal conditions (e.g., on days with different weather conditions, in different time periods of a day, different days in a week, different habits of the operator). When a subsequent sensor data 121 is classified outside of the “normal” clusters, an anomaly is detected.

Optionally, a supervised machine learning 171 can be used to train the ANN 125 (or other ANN). During the “normal” service period of the machine or a component, an expected classification can be used to label the sensor data 121. The supervised learning 171 can be used to minimize the classification differences between predictions made using the ANN 125 according to the sensor data 121 and the expected classification. Further, when the sensor data 121 is known to be “abnormal” (e.g., after a diagnosis or other determination/observation made in a maintenance service facility, or by the user or operator), the expected classification can be changed to “abnormal” for further training of the ANN 125 for direct recognition of the anomaly (e.g., instead of relying upon deviation from known “normal” clusters for an inference of anomaly). Thus, the ANN 125 (or other ANNs) can be trained to identify abnormal sensor data and estimate the degree of severity (e.g., a predetermined deviation from a normal value) in the anomaly to schedule a maintenance service.

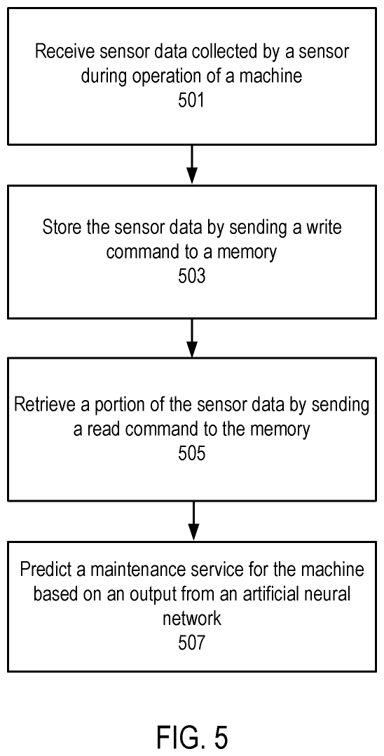

FIGS. 5-7 show methods of predictive maintenance, according to some embodiments. In one example, the methods of FIGS. 5-7 can be implemented for the machines in FIG. 1.

The methods of FIGS. 5-7 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIGS. 5-7 are performed at least in part by one or more processing devices (e.g., a processing device of server 119, or of memory device 101).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 5, at block 501, sensor data collected by a sensor during operation of a machine is received. In one example, sensor data 121 is collected by sensors 103, 108, 110.

At block 503, the sensor data is stored by sending a write command to a memory. In one example, sensor data is collected and stored in memory device 204. Processor 133 sends a write command to memory device 204 to store newly-received sensor data. Processor 133 continues to send write commands to store sensor data as a stream of data is received from sensors 103.

At block 505, a portion of the sensor data is retrieved by sending a read command to the memory. In one example, in preparation for predicting a maintenance service, processor 133 sends a read command to memory device 204 to obtain a portion of sensor data 206. In one example, processor 133 specifies a time period corresponding to or identifying the sensor data to be retrieved. In one example, processor 133 specifies a characteristic or classification used to select the sensor data to be retrieved.

At block 507, a maintenance service for the machine is predicted based on an output from an artificial neural network. In one example, processor 133 performs computations using artificial neural network 125 in order to predict a maintenance service for one of machines 210. In one example, memory device 204 predicts a maintenance service using spiking neural network 208. In one example, spiking neural network 208 and artificial neural network 125 are used in combination to define a maintenance service for one of machines 210 and/or to cause a change in control by machine controller 141. In one example, the change in control causes a change in an operating characteristic of a machine.

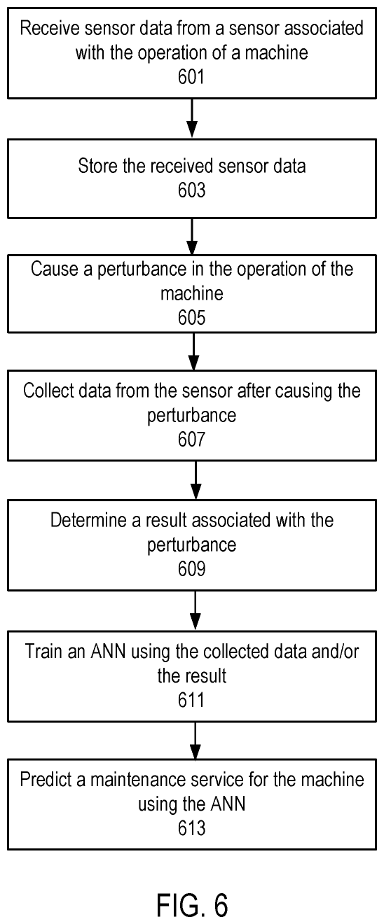

Referring to FIG. 6, at block 601, sensor data from a sensor associated with the operation of a machine is received. In one example, sensor data 103 is received by memory device 101.

At block 603, the received sensor data is stored. In one example, sensor data is stored by memory device 101. The sensor data is received by communication interface 124 from sensors 103, sensors 108, and/or sensors 110.

At block 605, a perturbance in the operation of the machine is caused. In one example, processor 133 initiates an artificial disturbance in the operation of a machine using machine controller 141. The artificial disturbance simulates a problem or situation associated with the operation of machine that is desired to be avoided in the future.

At block 607, data from the sensor is collected after causing the perturbance. In one example, sensor data is collected from sensors 103 to monitor changes that occur in operation due to the artificial disturbance. In one example, the sensor data is stored in memory device 204.

At block 609, a result associated with the perturbance is determined. In one example, processor 133 evaluates an operating condition of the machine based on sensor data 206, which has been collected after causing the perturbance.

At block 611, an artificial neural network is trained using the collected data and/or the result. In one example, SNN 208 is trained based on sensor data 206 and observed operation for one of machines 210.

At block 613, a maintenance service for the machine is predicted using the artificial neural network. In one example, an output from SNN 208 is used by processor 133 to predict a maintenance service for one of machines 210.

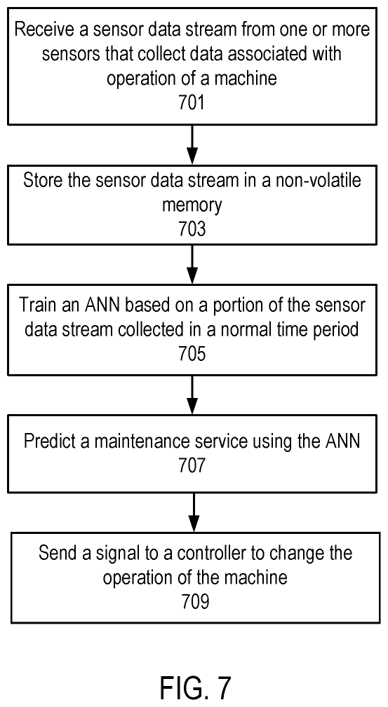

Referring to FIG. 7, at block 701, a sensor data stream is received from one or more sensors that collect data associated with operation of a machine. In one example, the sensor data stream is received from sensors 103, 108, and/or 110.

At block 703, the sensor data stream is stored in a non-volatile memory. In one example, the sensor data stream is stored in memory device 101 and/or 104. In one example, the sensor data stream is stored in black box data recorder 128.

At block 705, an artificial neural network is trained based on a portion of the sensor data stream collected in a time period of normal operation. In one example, ANN 122 is trained using sensor data stored in memory device 104 that corresponds to a time of normal operation for machines 106, 114, and/or 116.

At block 707, a maintenance service is predicted using the artificial neural network. In one example, ANN 112 is trained using sensor data from sensor 103 collected during a time of normal operation for machine 114. ANN 112 is used to predict a maintenance service for machine 114.

At block 709, based on the predicted maintenance service, a signal is sent to a controller to change the operation of the machine. In one example, memory device 101 uses communication interface 124 to send a control signal to a processing device of machine 114. The control signal causes an operating characteristic of machine 1142 change. In one example, the control signal causes machine 114 to initiate a maintenance sequence automatically implemented by machine 114.

In one embodiment, a system comprises: a communication interface (e.g., 124, communication device 139) configured to receive, over a network (e.g., 117), sensor data (e.g., 121, 206) collected by at least one sensor (e.g., 103, 108, 110) during operation of at least one machine (e.g., 106, 114, 116, or 210); memory (e.g., 101, 104, 204) configured to store the received sensor data, wherein the received sensor data comprises normal data patterns associated with the operation of the at least one machine; and a computing device (e.g., memory device 101, server 119, computer system 131) configured to predict a maintenance service for the at least one machine based on an output from an artificial neural network (ANN) (e.g., 112, 122, 125, and/or 208), wherein a portion of the received sensor data is an input to the ANN, and predicting the maintenance service comprises detecting an anomaly that deviates from at least one of the normal data patterns.

In one embodiment, the memory is a non-volatile memory device; and the computing device is further configured to store the received sensor data in the memory using a write command, and to retrieve the portion of the received sensor data from the memory using a read command.

In one embodiment, the at least sensor includes at least one of a microphone, a vibration sensor, a pressure sensor, a force sensor, a stress sensor, a deformation sensor, or an accelerometer.

In one embodiment, the memory is a black box data recorder (e.g., 128), and the computing device is further configured to: retrieve data from the black box data recorder in response to a determination that an accident of a first type has occurred; and train the ANN using the data retrieved from the black box data recorder, wherein the predicted maintenance service is configured to prevent a future accident of the first type.

In one embodiment, the computing device is further configured to signal, via the communication interface, a controller (e.g., 141, 143, 145) of a first machine of the at least one machine, wherein the signaling causes the controller to vary an operating characteristic (e.g., temperature, motion, velocity) of the first machine.

In one embodiment, the computing device is further configured to: determine a configuration based on the output from the ANN; and send the configuration to the controller, wherein the controller varies the operating characteristic based on the configuration.

In one embodiment, the at least one machine is part of an assembly line (e.g., 111) to manufacture products (e.g., 120), and the sensor data further comprises images of the products collected during or after assembly.

In one embodiment, the ANN includes a spiking neural network (e.g., SNN 208) trained to recognize the normal data patterns, and to detect the anomaly.

In one embodiment, the computing device is further configured to train the ANN using the sensor data that is collected within a predetermined time of the at least one machine being installed in an automated assembly line, manufactured, serviced, or repaired.

In one embodiment, the computing device is further configured to: cause an event (e.g., simulated artificial disturbance outside normal operating range by a predetermined deviation, such as more than 25% or more than 2-3 sigma standard deviation of a normal range or value of an operating parameter) of a first type that affects the operation of the at least one machine; collect first data during the event; and train the ANN using the first data. The predicted maintenance service is associated with preventing a future event of the first type.

In one embodiment, a method comprises: receiving, by a memory device, sensor data from at least one sensor associated with operation of at least one machine; storing, in a non-volatile storage media of the memory device, the received sensor data; and predicting a maintenance service for the at least one machine based on an output from an artificial neural network (ANN), wherein the ANN uses at least a portion of the received sensor data as an input.

In one embodiment, the ANN comprises a spiking neural network (SNN), and predicting the maintenance service comprises detecting, based on the output from the ANN, an anomaly that deviates from normal data patterns of operation for the at least one machine.

In one embodiment, the method further comprises: causing a perturbance in the operation of the at least one machine; collecting first data from the at least one sensor after causing the perturbance; determining a result of a first type associated with the perturbance; and training the ANN using at least one of the first data or the determined result. Predicting the maintenance service comprises identifying an action (e.g., self-maintenance sequence) for the at least one machine, and the action is configured to prevent a future result of the first type.

In one embodiment, the method further comprises, in response to predicting the maintenance service, causing an update of software (e.g., firmware 147, software on a machine 210) stored on the at least one machine, wherein the software controls the operation of the at least one machine.

In one embodiment, the method further comprises: identifying an occurrence of a predetermined type (e.g., types stored in a database in memory); in response to identifying the occurrence, retrieving a first portion of the sensor data stored in the memory device, wherein the first portion corresponds to a predetermined period of time prior to identifying the occurrence; and training the ANN using the first portion of the sensor data. Predicting the maintenance service comprises identifying a preemptive action to perform for the at least one machine.

In one embodiment, the occurrence of the predetermined type is an event that causes physical damage to the at least one machine, or a product manufactured using the at least one machine.

In one embodiment, a non-transitory computer-readable medium stores instructions which, when executed on a memory device, cause the memory device to: receive, over a network, a sensor data stream from at least one sensor that collects data associated with operation of a machine; store the received sensor data stream in a non-volatile memory; predict a maintenance service based on an output from an artificial neural network (ANN), wherein a portion of the sensor data stream is an input to the ANN; and signal, over the network and based on the predicted maintenance service, a controller of the machine to cause a change in the operation of the machine.

In one embodiment, the ANN is configured to be self-trained via unsupervised machine learning to detect anomaly.

In one embodiment, the instructions further cause the memory device to train the ANN. The training is based on a classification that the sensor data stream collected within a predetermined time period is normal, the ANN is configured to detect anomaly, and the ANN includes a spiking neural network.

In one embodiment, the at least one sensor (e.g., 103, 108, 110) is at least one of mounted in vicinity of the machine, attached to the machine, installed in the machine, or configured to measure motion parameters of the machine.

In one example, the artificial neural network (ANN) can be configured to identify a component of a vehicle or other machine that needs repair or replacement in the maintenance service and/or identify a predicted time period to failure or malfunctioning of the component, or a suggested time period to a recommended maintenance service of the component prior the failure or malfunctioning of the component. Thus, the performance of the predicted maintenance service can avoid an incident of failure or malfunctioning of the component while the vehicle operates on the road.

In one example, the sensor 103 can be a microphone mounted in vicinity of the component, a vibration sensor attached to the component, a pressure sensor installed in the component, a force or stress sensor mounted on or attached to the component, a deformation sensor attached to the component, an accelerometer configured to measure motion parameters of the component.

Optionally, the memory device (e.g., 101, 104, 204), the computer system 131, and/or server 119 remote from the machines can have a machine-learning module configured to train the artificial neural network (ANN) during a period of time in which the machine(s) is assumed to be in a healthy state, such as a predetermined time period from a vehicle or other machine leaving a factory or a maintenance service facility.

In one example, the machine learning module can use an unsupervised machine learning to train the ANN to recognize/classify normal patterns of sensor data and thus to have the capability to detect anomaly based on deviation from the normal patterns. Alternatively, supervised machine learning can be used.

In one example, unsupervised machine learning can be applied by the memory device or the computer system 131 during the predetermined period of time in which the machine and/or the component is known to be operating without troubles or degradations. Alternatively, or in combination, some of the sensor data stored in the memory device can be uploaded to the server 119 for training the ANN. The server 119, the computer system 131, and/or, the memory device can each be implemented as one or more data processing systems that each include a processing device and memory.

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system comprising:
a communication interface configured to receive, over a network, sensor data collected by at least one sensor during operation of at least one machine;
memory configured to store the received sensor data, wherein the received sensor data comprises normal data patterns associated with the operation of the at least one machine; and
a computing device configured to predict a maintenance service for the at least one machine based on an output from an artificial neural network (ANN), wherein a portion of the received sensor data is an input to the ANN, and predicting the maintenance service comprises detecting an anomaly that deviates from at least one of the normal data patterns.

2. The system of claim 1, wherein:
the memory is a non-volatile memory device; and
the computing device is further configured to store the received sensor data in the memory using a write command, and to retrieve the portion of the received sensor data from the memory using a read command.

3. The system of claim 1, wherein the at least sensor includes at least one of a microphone, a vibration sensor, a pressure sensor, a force sensor, a stress sensor, a deformation sensor, or an accelerometer.

4. The system of claim 1, wherein the memory is a black box data recorder, and the computing device is further configured to:
retrieve data from the black box data recorder in response to a determination that an accident of a first type has occurred; and
train the ANN using the data retrieved from the black box data recorder, wherein the predicted maintenance service is configured to prevent a future accident of the first type.

5. The system of claim 1, wherein the computing device is further configured to signal, via the communication interface, a controller of a first machine of the at least one machine, wherein the signaling causes the controller to vary an operating characteristic of the first machine.

6. The system of claim 5, wherein the computing device is further configured to:
determine a configuration based on the output from the ANN; and
send the configuration to the controller, wherein the controller varies the operating characteristic based on the configuration.

7. The system of claim 1, wherein the at least one machine is part of an assembly line to manufacture products, and the sensor data further comprises images of the products collected during or after assembly.

8. The system of claim 1, wherein the ANN includes a spiking neural network trained to recognize the normal data patterns, and to detect the anomaly.

9. The system of claim 1, wherein the computing device is further configured to train the ANN using the sensor data that is collected within a predetermined time of the at least one machine being installed in an automated assembly line, manufactured, serviced, or repaired.

10. The system of claim 1, wherein the computing device is further configured to:
cause an event of a first type that affects the operation of the at least one machine;
collect first data during the event; and
train the ANN using the first data;
wherein the predicted maintenance service is associated with preventing a future event of the first type.

11. A method comprising:
receiving, by a memory device, sensor data from at least one sensor associated with operation of at least one machine;
storing, in a non-volatile storage media of the memory device, the received sensor data; and
predicting a maintenance service for the at least one machine based on an output from an artificial neural network (ANN), wherein the ANN uses at least a portion of the received sensor data as an input.

12. The method of claim 11, wherein the ANN comprises a spiking neural network (SNN), and predicting the maintenance service comprises detecting, based on the output from the ANN, an anomaly that deviates from normal data patterns of operation for the at least one machine.

13. The method of claim 11, further comprising:
causing a perturbance in the operation of the at least one machine;
collecting first data from the at least one sensor after causing the perturbance;
determining a result of a first type associated with the perturbance; and
training the ANN using at least one of the first data or the determined result;
wherein predicting the maintenance service comprises identifying an action for the at least one machine, and wherein the action is configured to prevent a future result of the first type.

14. The method of claim 13, further comprising, in response to predicting the maintenance service, causing an update of software stored on the at least one machine, wherein the software controls the operation of the at least one machine.

15. The method of claim 11, further comprising:
identifying an occurrence of a predetermined type;
in response to identifying the occurrence, retrieving a first portion of the sensor data stored in the memory device, wherein the first portion corresponds to a predetermined period of time prior to identifying the occurrence; and
training the ANN using the first portion of the sensor data;
wherein predicting the maintenance service comprises identifying a preemptive action to perform for the at least one machine.

16. The method of claim 15, wherein the occurrence of the predetermined type is an event that causes physical damage to the at least one machine, or a product manufactured using the at least one machine.

17. A non-transitory computer-readable medium storing instructions which, when executed on a memory device, cause the memory device to:
receive, over a network, a sensor data stream from at least one sensor that collects data associated with operation of a machine;
store the received sensor data stream in a non-volatile memory;
predict a maintenance service based on an output from an artificial neural network (ANN), wherein a portion of the sensor data stream is an input to the ANN; and
signal, over the network and based on the predicted maintenance service, a controller of the machine to cause a change in the operation of the machine.

18. The non-transitory computer-readable medium of claim 17, wherein the ANN is configured to be self-trained via unsupervised machine learning to detect anomaly.

19. The non-transitory computer-readable medium of claim 17, wherein the instructions further cause the memory device to train the ANN; and wherein the training is based on a classification that the sensor data stream collected within a predetermined time period is normal, the ANN is configured to detect anomaly, and the ANN includes a spiking neural network.

20. The non-transitory computer-readable medium of claim 17, wherein the at least one sensor is at least one of mounted in vicinity of the machine, attached to the machine, installed in the machine, or configured to measure motion parameters of the machine.
